(19) United States
(12) Patent Application Publication
(10) Pub. No.: US 2025/0223443 A1
(43) Pub. Date: Jul. 10, 2025

(54) SILICONE EMULSION

(71) Applicant: BASF SE, Ludwigshafen am Rhein (DE)

(72) Inventors: Francis Ming Hei CHOI, Wyandotte, MI (US); Padma P VARANASI, Wyandotte, MI (US)

(73) Assignee: BASF SE, Ludwigshafen am Rhein (DE)

(21) Appl. No.: 18/853,844

(22) PCT Filed: May 9, 2023
(86) PCT No.: PCT/US2023/021544

§ 371 Date: Oct. 3, 2024

Related U.S. Application Data
(60) Provisional application No. 63/365,513, filed on May 31, 2022.

(51) Int. Cl. C08L 83/04; C08J 3/03; C08J 3/09

(52) U.S. Cl. CPC C08L 83/04; C08J 3/03; C08J 3/09

(57) ABSTRACT

Described herein are silicone emulsions, methods of making silicone emulsions, and methods of using silicone emulsions. The silicone emulsions are stabilized by the combination of a polar additive and a surfactant in a form of a liquid crystal. The silicone emulsions are useful in a variety of industrial applications.

### CROSS-REFERENCE TO RELATED APPLICATIONS

This application claims priority from U.S. Provisional Application No. 63/365,513, filed May 31, 2022, which is hereby incorporated by reference herein.

### FIELD OF DISCLOSURE

This disclosure is directed to silicone emulsions, methods of making silicone emulsions, and methods of using silicone emulsions. The silicone emulsions are stabilized by the combination of a polar additive and a surfactant in a form of a liquid crystal. The silicone emulsions are useful in a variety of industrial applications.

### BACKGROUND

Silicone oils are a broad range of fluids, including linear chains of poly (dimethylsiloxane) with varying degrees of polymerization and viscosities. The viscosity can range from 0.65-1,000,000 s of cSt, depending on the degree of polymerization. For ease of application in areas including sealants, coatings, and defoamers, silicone oil is emulsified into a waterborne dispersion with micron-sized droplets and reduced viscosity. Waterborne silicone emulsions require stabilizers, such as a surfactant, polymer, or solid particle, to prevent silicone oil droplets from coalescing and from creaming to maintain the particle size and a uniform dispersion of droplets throughout the emulsion. Conventional silicone oil emulsions are thus composed of an aqueous phase, a silicone oil phase, and a stabilizer.

While many surfactants can disperse silicone oils into a continuous water phase, not all surfactants can maintain the required stability. Surfactants reduce the interfacial tension between the silicone oil and aqueous phase in silicone emulsions, thereby aiding in the reduction of droplet size. During the catastrophic inversion process for producing oil-in-water (o/w) emulsions, as water is gradually added to a surfactant-silicone oil mixture, some surfactants also produce a lyotropic liquid crystal in the aqueous phase. The highly viscous structures of lyotropic liquid crystals reduce the viscosity ratio between the aqueous phase and the silicone oil, thereby enabling better transfer of stresses towards the deformation of the silicone oil drops, and resulting in break-up. This liquid crystal phase typically forms at high surfactant concentrations (often exceeding 40% surfactant in water), so it is a temporary structure that exists during catastrophic inversion and depending on the surfactant, may disappear after all water has been added.

While surfactants and the presence of intermediate liquid crystal phases during catastrophic inversion is essential to achieving small droplet sizes, these silicone oil emulsions may or may not remain stable. Some silicone oil emulsions coalesce and undergo bulk phase separation. Others may be stable against coalescence but undergo creaming. The difference is hypothesized to result from the fact that at the end surfactant concentration (less than about 20% surfactant in water), certain surfactants continue to exist as liquid crystals while other surfactants form into micelles. It is known that liquid crystals provide three mechanisms beneficial to emulsion stability: 1) a protective viscous skin at the oil-water interface, 2) a three-dimensional network that reduces droplet mobility, and 3) steric repulsion. The ability to formulate liquid crystals at the end concentration is therefore essential to achieving stable silicone oil emulsions.

According to the critical packing parameter for surfactants, the ratio between the cross-sectional area of the head group and the tail dictates the structure that is formed. A surfactant with a much larger head relative to the tail tends to form spherical micelles, while a surfactant with roughly equal areas for both the head and tail tends to form a lamellar-type structure. Surfactants that tend to form lamellar-type structures also tend to form liquid crystals at lower surfactant concentrations compared to surfactants that tend to form spherical micelles. However, this natural limitation often prevents the use of surfactants that tend to form spherical micelles, and consequently limits the number and type of surfactants that can be used to stabilize silicone oil emulsions.

Accordingly, the present application seeks to expand the available surfactants that form liquid crystals in order to stabilize silicone oil emulsions.

Described herein are silicone emulsions, methods of making silicone emulsions, and methods of using silicone emulsions. The silicone emulsions are stabilized by the combination of a polar additive and a surfactant in a form of a liquid crystal.

### BRIEF DESCRIPTION OF THE DISCLOSURE

In one aspect, provided herein is an emulsion comprising: a silicone oil; and a liquid crystal comprising: an aqueous solvent; a polar additive; and a surfactant; wherein the surfactant is present in an amount of less than about 20 wt. % of the emulsion.

In another aspect, provided herein is a method of making an emulsion comprising: a silicone oil; and a liquid crystal comprising: an aqueous solvent; a polar additive; and a surfactant; wherein the surfactant is present in an amount of less than about 20 wt. % of the emulsion, the method comprising: (i) forming a mixture comprising: a first amount of the aqueous solvent; optionally a first amount of the silicone oil; the polar additive; and the surfactant, wherein the surfactant is optionally in a form of a liquid crystal; (ii) mixing the mixture; (iii) optionally adding a second amount of the silicone oil; and (iv) optionally adding a second amount of the aqueous solvent.

In yet another aspect, provided herein is a method of using an emulsion comprising: a silicone oil; and a liquid crystal comprising: an aqueous solvent; a polar additive; and a surfactant; wherein the surfactant is present in an amount of less than about 20 wt. % of the emulsion, the method comprising using the emulsion to form a product selected from the group of sealant compositions, coating compositions, adhesive compositions, elastomer compositions, release agent compositions, texture enhancing compositions, lubricant compositions, defoaming compositions, gloss providing compositions, construction compositions, building material compositions, clay compositions, concrete compositions, concrete compositions for improving water repellency, and personal care compositions.

### BRIEF DESCRIPTION OF THE DRAWINGS

FIG. 1 is an exemplary embodiment in accordance with the present disclosure of photographs depicting silicone emulsions including varying amounts of silicone oil, surfactant, and polar additive.

FIG. 2 is an exemplary embodiment in accordance with the present disclosure of photographs depicting silicone emulsions including varying amounts of silicone oil, surfactant, and polar additive.

FIG. 3 is an exemplary embodiment in accordance with the present disclosure of photographs depicting silicone emulsions including a polar additive to solve creaming issues.

FIG. 4A is an exemplary embodiment in accordance with the present disclosure of a microscope image at 40× of a silicone oil emulsion containing 12,500 cSt silicone oil.

FIG. 4B is an exemplary embodiment in accordance with the present disclosure of a photograph depicting a silicone oil emulsion containing 12,500 cSt silicone oil.

FIG. 5A is an exemplary embodiment in accordance with the present disclosure of a microscope image at 40× of a silicone oil emulsion containing 1,000,000 cSt silicone oil.

FIG. 5B is an exemplary embodiment in accordance with the present disclosure of a photograph depicting a silicone oil emulsion containing 1,000,000 cSt silicone oil.

FIG. 6 is an exemplary embodiment in accordance with the present disclosure of photographs depicting silicone emulsions including varying amounts of silicone oil, surfactant, and polar additive.

FIG. 7A is an exemplary embodiment in accordance with the present disclosure of a microscope image at 40× of a silicone oil emulsion containing 1,000,000 cSt silicone oil.

FIG. 7B is an exemplary embodiment in accordance with the present disclosure of a photograph depicting a silicone oil emulsion containing 1,000,000 cSt silicone oil.

FIG. 8 is an exemplary embodiment in accordance with the present disclosure of photographs depicting silicone emulsions including varying amounts of silicone oil, surfactant, and polar additive.

FIG. 9 is an exemplary embodiment in accordance with the present disclosure of photographs depicting silicone emulsions including varying amounts of silicone oil, surfactant, stabilizer, and polar additive.

### DETAILED DESCRIPTION OF THE DISCLOSURE

The present disclosure is directed to silicone emulsions, methods of making silicone emulsions, and methods of using silicone emulsions. The silicone emulsions comprise a silicone oil; and a liquid crystal comprising: an aqueous solvent; a polar additive; and a surfactant. The surfactant is present in the emulsions in an amount of less than about 20 wt. % of the emulsions.

The present application seeks to expand the available surfactants that form liquid crystals in order to stabilize silicone oil emulsions. The demonstrated surfactants do not produce liquid crystals at the end surfactant concentration without additional components. Rather, this goal is accomplished with a polar additive, such as a polar oil or alcohol, which changes the effective packing parameter of the surfactant. When these additives are gradually introduced into surfactant-water solutions that form micellar solutions, the micellar structures change into liquid crystals. This produces a clear difference in viscosity and provides the solution with a yield stress and a shear thinning behavior that is favorable for resisting particle sedimentation and creaming. Birefringence can also be observed when the sample is viewed under cross-polarized light.

The present application provides several advantages. First, the use of additives to produce liquid crystals expands the number of surfactants that may be used to make stable silicone oil emulsions. New classes of surfactants may be explored with this approach. Second, these additives may contribute to a further reduction in interfacial tension, resulting in smaller droplet sizes when undergoing catastrophic inversion. Third, these additives may provide the fluid with a more favorable rheological profile. A yield point provides good stability at rest and a shear thinning behavior allows for flow without high pressure. Fourth, these additives may be added at multiple stages of the process, including in the beginning or as a post-emulsion additive.

Generally, the emulsion may be in the form of any suitable emulsion form known in the art. In some embodiments, the emulsion is an oil-in-water emulsion or a water-in-oil emulsion. In some embodiments, the emulsion is an oil-in-water emulsion.

In many embodiments, the surfactant may be any suitable surfactant known in the art. In some embodiments, the surfactant is selected from the group of ionic surfactants, cationic surfactants, anionic surfactants, amphoteric surfactants, zwitterionic surfactants, nonionic surfactants, alcohol ethoxylates, alcohol alkoxylates, alkyl polyglycosides, alkyl polyglucosides, extended surfactants, surfactants that include intermediate propoxylate groups in between the head group and the tail, and combinations thereof. Examples of suitable surfactants include alcohol ethoxylates such as Lutensol® XL79 and/or Lutensol® TO8, alkylpolyglucosides such as Glucopon® 625, or extended surfactants such as Aspiro® S8310.

In many embodiments, the surfactant may be present in the emulsion in any suitable amount known in the art. Generally, the surfactant is present in an amount that is less than an amount required to form a liquid crystal in the absence of the polar additive.

In some embodiments, the surfactant is present in an amount of less than or equal to about 20 wt. %, about 19 wt. %, about 18 wt. %, about 17 wt. %, about 16 wt. %, about 15 wt. %, about 14 wt. %, about 13 wt. %, about 12 wt. %, about 11 wt. %, about 10 wt. %, about 9 wt. %, about 8 wt. %, about 7 wt. %, about 6 wt. %, about 5 wt. %, about 4 wt. %, about 3 wt. %, about 2 wt. %, or about 1 wt. % of the emulsion. In some embodiments, the surfactant is present in an amount of greater than or equal to about 0.1 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, or about 19 wt. % of the emulsion.

In some embodiments, the surfactant comprises a surfactant that is otherwise not in the form of a liquid crystal when present in an amount of less than about 20 wt. % of the emulsion in the absence of the polar additive. In some embodiments, the surfactant comprises a surfactant that is in the form of a micellar structure, a spherical structure, a rod-like structure, a worm-like micellar structure, or combinations thereof when present in an amount of less than about 20 wt. % of the emulsion in the absence of the polar additive.

In many embodiments, the liquid crystal may be selected from any type of suitable liquid crystal known in the art. In some embodiments, the liquid crystal is a lyotropic liquid crystal.

In many embodiments, the polar additive may be any suitable polar additive known in the art. In some embodiments, the polar additive is selected from the group of polar oils, alcohols, surfactants, polar surfactants, and combinations thereof. Examples of suitable polar additives include fatty alcohols such as Lorol® C10, polar oils such as Agnique® AE 3-2EH, and polar surfactants such as NANSA® EVM 70/2E.

In many embodiments, the polar additive may be any suitable polar additive known in the art. In some embodiments, the polar additive may be any suitable polar oil known in the art. Polar oils are generally sparingly soluble in water and do not include alkanes. In some embodiments, the polar additive is a polar oil selected from the group of alkyl esters, fatty acids, polar aromatics, and combinations thereof.

In some embodiments, the polar additive is a surfactant. In some embodiments, the surfactant is selected from the group of ionic surfactants, cationic surfactants, anionic surfactants, amphoteric surfactants, zwitterionic surfactants, nonionic surfactants, alcohol ethoxylates, alcohol alkoxylates, alkyl polyglycosides, alkyl polyglucosides, extended surfactants, surfactants that include intermediate propoxylate groups in between the head group and the tail, and combinations thereof.

In many embodiments, the polar additive may be present in the emulsion in any suitable amount known in the art. In some embodiments, the polar additive is present in an amount of less than or equal to about 20 wt. %, about 19 wt. %, about 18 wt. %, about 17 wt. %, about 16 wt. %, about 15 wt. %, about 14 wt. %, about 13 wt. %, about 12 wt. %, about 11 wt. %, about 10 wt. %, about 9 wt. %, about 8 wt. %, about 7 wt. %, about 6 wt. %, about 5 wt. %, about 4 wt. %, about 3 wt. %, about 2 wt. %, or about 1 wt. % of the emulsion. In some embodiments, the polar additive is present in an amount of greater than or equal to about 0.1 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, or about 19 wt. % of the emulsion.

In many embodiments, the polar additive may be present in the emulsion relative to the amount of surfactant in any suitable amount known in the art. In some embodiments, the polar additive is present in a weight fraction (wt. fraction) relative to the surfactant of less than or equal to about 5.0, about 4.5, about 4.0, about 3.5, about 3.0, about 2.5, about 2.0, about 1.5, about 1.0, about 0.95, about 0.90, about 0.85, about 0.80, about 0.75, about 0.70, about 0.65, about 0.60, about 0.55, about 0.50, about 0.45, about 0.40, about 0.35, about 0.30, about 0.25, about 0.20, about 0.15, about 0.10, or about 0.05. In some embodiments, the polar additive is present in a wt. fraction relative to the surfactant of more than or equal to about 0.05, about 0.10, about 0.15, about 0.20, about 0.25, about 0.30, about 0.35, about 0.40, about 0.45, about 0.50, about 0.55, about 0.60, about 0.65, about 0.70, about 0.75, about 0.80, about 0.85, about 0.90, about 0.95, about 1.0, about 1.5, about 2.0, about 2.5, about 3.0, about 3.5, about 4.0, about 4.5, or about 5.0.

In some embodiments, the polar additive is present in a weight fraction (wt. fraction) relative to the surfactant of less than or equal to about 0.50, about 0.45, about 0.40, about 0.35, about 0.30, about 0.25, about 0.20, about 0.15, about 0.10, or about 0.05. In some embodiments, the polar additive is present in a wt. fraction relative to the surfactant of more than or equal to about 0.05, about 0.10, about 0.15, about 0.20, about 0.25, about 0.30, about 0.35, about 0.40, about 0.45, or about 0.50.

In many embodiments, the aqueous solvent may be any suitable aqueous solvent known in the art. In some embodiments, the aqueous solvent comprises water. In some embodiments, the aqueous solvent comprises deionized water. In some embodiments, the aqueous solvent is substantially free from salt.

In some embodiments, the aqueous solvent comprises a salt. The presence of a salt is particularly beneficial when the emulsion comprises an anionic surfactant. The presence of a salt is also particularly beneficial when the emulsion comprises a cationic surfactant. The salts may be inorganic salts or organic salts. Examples of suitable salts include salts containing cations such as Na⁺ and Ca²⁺, in combination with anions such as Cl⁻, Br⁻, CO₃²⁻, or salicylate.

In many embodiments, the silicone oil may be any suitable silicone oil known in the art. In some embodiments, the silicone oil is from a class of silicone oils selected from the group of epoxy, mercapto, phenyl, reactive, and combinations thereof. In some embodiments, the silicone oil is selected from the group of polydimethylsiloxanes, organo-modified silicones, amino-modified silicones, methyl silicone resins, MQ resins, and combinations thereof.

In some embodiments, the silicone oil has a viscosity in a range of from about 0.65 to about 1,500,000 cSt. In some embodiments, the silicone oil has a viscosity in a range of from about 0.65 to about 1,000,000 cSt.

In many embodiments, the emulsified silicone oil droplets may be of any suitable size known in the art. In some embodiments, the emulsified silicone oil droplets comprise a size dimension on the order of microns. In some embodiments, the emulsified silicone oil droplets have a diameter in the range of from about 0.5 to about 100 micrometers. In some embodiments, the emulsified silicone oil droplets have a diameter in the range of from about 0.5 to about 10 micrometers.

In many embodiments, the emulsion may further comprise any suitable emulsion components known in the art. In some embodiments, the emulsion comprises a stabilizer selected from the group of surfactants, polymers, solid particles, surface-active proteins, fibers, clays, temperature stabilizers, and combinations thereof. In some embodiments, the stabilizer comprises an alkoxylated polymer. In some embodiments, the stabilizer comprises an alkoxylated block copolymer. In some embodiments, the stabilizer comprises an ethoxylated/propoxylated (EO/PO) block copolymer. In some embodiments, the stabilizer comprises Pluronic® P105.

In many embodiments, the emulsion is storage stable. In some embodiments, the emulsion is storage stable for at least one month. In some embodiments, the emulsion is storage stable at high temperatures. In some embodiments, the emulsion is storage stable at temperatures up to about 80° C. Storage at high temperatures is particularly useful when the emulsion comprises a temperature-insensitive surfactant or temperature-insensitive surfactant blend.

Generally, the emulsion may be made according to any suitable method known in the art. In some embodiments, the emulsion is made according to a method comprising (i) forming a mixture comprising optionally a first amount of an aqueous solvent; optionally a first amount of a silicone oil; a polar additive; and a surfactant, wherein the surfactant is optionally in a form of a liquid crystal; (ii) mixing the mixture; (iii) optionally adding a second amount of the silicone oil; and (iv) optionally adding a second amount of the aqueous solvent.

In many embodiments, the polar additive may be added at any stage of the method. In some embodiments, the polar additive is added to the surfactant to form a blend. The blend may be added to a silicone oil or the silicone oil may be added to the blend. In some embodiments, the polar additive is added to a mixture comprising the aqueous solvent and the surfactant. In some embodiments, the polar additive is added to a mixture comprising the silicone oil and the surfactant.

In some embodiments, the method step of forming a mixture comprises (i) forming a first mixture comprising optionally the first amount of the aqueous solvent, the silicone oil, and the surfactant; and (ii) adding to the first mixture the polar additive to form a second mixture.

In some embodiments, the emulsion is made according to a method comprising (i) forming a first mixture comprising a first amount of an aqueous solvent, a silicone oil, and a surfactant; (ii) mixing the first mixture; and (iii) adding to the first mixture the polar additive to form a second mixture.

In some embodiments, the method step of forming a mixture comprises (i) forming a first mixture comprising optionally the first amount of the aqueous solvent, the polar additive, and the surfactant; and (ii) adding the first mixture to the silicone oil to form a second mixture.

In some embodiments, the emulsion is made according to a method comprising (i) forming a first mixture comprising optionally a first amount of an aqueous solvent, a polar additive, and a surfactant; (ii) adding the first mixture to the silicone oil to form a second mixture, (iii) mixing the second mixture, and (iv) adding a second amount of the aqueous solvent.

In many embodiments, the surfactant may be in any suitable form during the method step of forming a mixture. In some embodiments, the surfactant is not in a form of a liquid crystal during the method step of forming a mixture. In some embodiments, the surfactant is in the form of a micellar structure, a spherical structure, a rod-like structure, a worm-like micellar structure, or combinations thereof during the method step of forming a mixture.

In many embodiments, the method step of mixing the mixture comprises mixing the mixture at a suitable rate. Generally, higher speeds are desired to produce smaller droplet sizes, while lower speeds are desired to produce larger droplet sizes and/or limit shear rates. In some embodiments, the method step of mixing the mixture comprises mixing the mixture at a rate of less than or equal to about 10000 rpm. In some embodiments, the method step of mixing the mixture comprises mixing the mixture at a rate of less than or equal to about 1000 rpm. In some embodiments, the method step of mixing the mixture comprises mixing the mixture at a rate of less than or equal to about 300 rpm.

In many embodiments, the method step of mixing the mixture comprises mixing the mixture according to any suitable mixing procedure known in the art. In some embodiments, the method step of mixing the mixture comprises mixing the mixture with a mixer, such as an overhead mixer or a static mixer.

Generally, the emulsion undergoes catastrophic inversion during the method of making. In some embodiments, the method step of adding a first amount of the aqueous solvent induces catastrophic inversion of the emulsion. In some embodiments, the method step of adding a second amount of the aqueous solvent induces catastrophic inversion of the emulsion. In some embodiments, the method comprises a method step of adding a first amount of the aqueous solvent to induce catastrophic inversion of the emulsion, followed by a method step of adding a second amount of aqueous solvent after catastrophic inversion has occurred.

In some embodiments, the emulsion does not undergo catastrophic inversion during the method of making. In some embodiments where the emulsion does not undergo catastrophic inversion during the method of making, the method of making comprises direct emulsification, whereby the desired components of the emulsion are simultaneously mixed together. In some embodiments where the emulsion does not undergo catastrophic inversion during the method of making, the method of making comprises addition of silicone oil after formation of the liquid crystal.

In these embodiments, catastrophic inversion describes the change of the emulsion from being oil-continuous to water-continuous. In some embodiments, catastrophic inversion is detectable by a sharp increase in the conductivity of the fluid. In some embodiments, the conductivity is less than about 5-10 μS when oil-continuous, and sharply increases by several orders of magnitude during inversion to water-continuous.

Generally, numerous compositions may comprise the silicone emulsions in accordance with the present disclosure. The silicone emulsions may also be used in numerous compositions.

In many embodiments, the composition is a composition useful for an industrial application. In some embodiments, the composition is selected from the group of sealant compositions, coating compositions, adhesive compositions, elastomer compositions, release agent compositions, texture enhancing compositions, lubricant compositions, defoaming compositions, gloss providing compositions, construction compositions, building material compositions, clay compositions, concrete compositions, concrete compositions for improving water repellency, and personal care compositions.

Further aspects of the present disclosure are provided by the subject matter of the following clauses:

1. An emulsion comprising:
a silicone oil; and
a liquid crystal comprising:
   an aqueous solvent;
   a polar additive; and
   a surfactant;
wherein the surfactant is present in an amount of less than about 20 wt. % of the emulsion.

2. The emulsion of the preceding clause, wherein the surfactant is selected from the group of ionic surfactants, cationic surfactants, anionic surfactants, amphoteric surfactants, zwitterionic surfactants, nonionic surfactants, alcohol ethoxylates, alcohol alkoxylates, alkyl polyglycosides, alkyl polyglucosides, extended surfactants, surfactants that include intermediate propoxylate groups in between the head group and the tail, and combinations thereof.

3. The emulsion of any preceding clause, wherein the surfactant is present in an amount of less than about 15 wt. % of the emulsion.

4. The emulsion of any preceding clause, wherein the surfactant comprises a surfactant that is otherwise not in the form of a liquid crystal when present in an amount of less than about 20 wt. % of the emulsion in the absence of the polar additive.

5. The emulsion of any preceding clause, wherein the liquid crystal is a lyotropic liquid crystal.

6. The emulsion of any preceding clause, wherein the polar additive is selected from the group of polar oils, alcohols, alkyl esters, fatty acids, polar aromatics, surfactants, polar surfactants, and combinations thereof.

7. The emulsion of any preceding clause, the polar additive is present in a wt. fraction relative to the surfactant in a range of from about 0.25 to about 5.0.

8. The emulsion of any preceding clause, wherein the aqueous solvent comprises water.

9. The emulsion of any preceding clause, wherein the silicone oil is selected from the group of polydimethylsiloxanes, organo-modified silicones, amino-modified silicones, methyl silicone resins, MQ resins, and combinations thereof.

10. The emulsion of any preceding clause, wherein the silicone oil has a viscosity in a range of from about 0.65 to about 1,500,000 cSt.

11. The emulsion of any preceding clause, further comprising a stabilizer selected from the group of surfactants, polymers, solid particles, surface-active proteins, fibers, clays, temperature stabilizers, and combinations thereof.

12. The emulsion of any preceding clause, wherein the emulsion is an oil-in-water emulsion.

13. The emulsion of any preceding clause, wherein the composition is selected from the group of sealant compositions, coating compositions, adhesive compositions, elastomer compositions, release agent compositions, texture enhancing compositions, lubricant compositions, defoaming compositions, gloss providing compositions, construction compositions, building material compositions, clay compositions, concrete compositions, concrete compositions for improving water repellency, and personal care compositions.

14. A method of making an emulsion comprising:
a silicone oil; and
a liquid crystal comprising:
   an aqueous solvent;
   a polar additive; and
   a surfactant;
wherein the surfactant is present in an amount of less than about 20 wt. % of the emulsion,
the method comprising:
   forming a mixture comprising:
      optionally a first amount of the aqueous solvent;
      optionally a first amount of the silicone oil;
      the polar additive; and
      the surfactant, wherein the surfactant is optionally in a form of a liquid crystal;
   mixing the mixture;
   optionally adding a second amount of the silicone oil; and
   optionally adding a second amount of the aqueous solvent.

15. The emulsion of the preceding clause, wherein the method step of forming a mixture comprises:
forming a first mixture comprising the first amount of the silicone oil and the surfactant; and
adding to the first mixture the polar additive to form a second mixture.

16. The emulsion of any preceding clause, wherein the method step of forming a mixture comprises:
forming a first mixture comprising the first amount of the aqueous solvent, the polar additive, and the surfactant; and
adding to the first mixture the first amount of the silicone oil to form a second mixture.

17. The emulsion of any preceding clause, wherein the method step of mixing the mixture comprises mixing the mixture at a rate of less than or equal to about 300 rpm.

18. The emulsion of any preceding clause, wherein the method step of adding a second amount of the aqueous solvent induces catastrophic inversion of the emulsion.

19. The emulsion of any preceding clause, wherein the surfactant is not in a form of a liquid crystal during the method step of forming a mixture.

20. A method of using an emulsion comprising:
a silicone oil; and
a liquid crystal comprising:
   an aqueous solvent;
   a polar additive; and
   a surfactant;
wherein the surfactant is present in an amount of less than about 20 wt. % of the emulsion,
   the method comprising using the emulsion to form a product selected from the group of sealant compositions, coating compositions, adhesive compositions, elastomer compositions, release agent compositions, texture enhancing compositions, lubricant compositions, defoaming compositions, gloss providing compositions, construction compositions, building material compositions, clay compositions, concrete compositions, concrete compositions for improving water repellency, and personal care compositions.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever.

### Materials

Lutensol® XL79: nonionic alkyl polyethylene glycol ether surfactant.
Lutensol® TO 8: nonionic surfactant based on a saturated iso-C₁₃-alcohol.
Glucopon® 625UP: alkyl polyglycosides surfactant.
Lorol® C10: 1-decanol.
Agnique® AE 3-2EH: 2-ethylhexyl lactate.
Aspiro S8310: anionic extended surfactant.
Lutensol® XL70: nonionic alkyl polyethylene glycol ether surfactant.
NANSA® EVM 70/2E: linear dodecylbenzene sulfonate, calcium salt in 2-ethyhexanol/propylene glycol solvent.
Pluronic® P105: Nonionic EO/PO Block Copolymer, 50% EO.

### Example 1. Silicone Emulsions With 8.5 wt. % Surfactant and Varying Amounts of Polar Additive

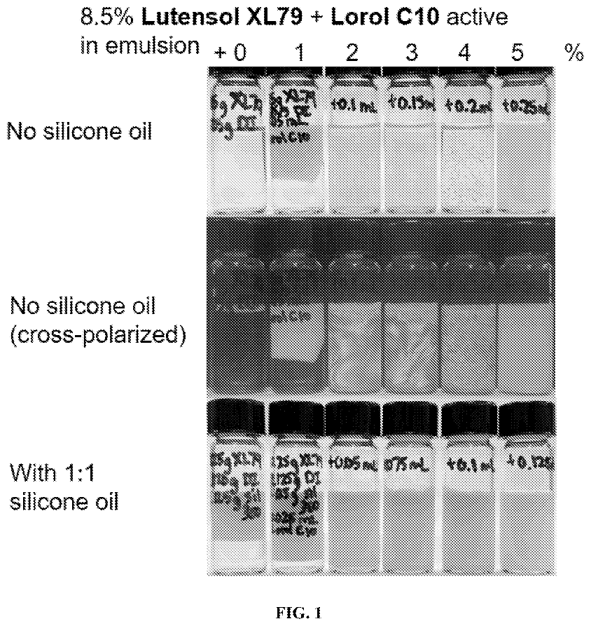

Silicone emulsions were formed with water, silicone oil, 8.5 wt. % active surfactant (Lutensol® XL79), and varying amounts of polar additive (Lorol® C10). The emulsions were formed by direct emulsification, followed by vortex-mixing for two minutes. This process was performed twice, with a four-hour time gap between each mixing. Related compositions are shown in FIG. 1. In the top images of FIG. 1, compositions including water, surfactant, and polar additive are shown under ordinary light. In the middle images of FIG. 1, compositions including water, surfactant, and polar additive are shown under cross-polarized light. In the bottom images of FIG. 1, compositions including water, surfactant, polar additive, and silicone oil are shown under ordinary light.

As can be seen in the middle images of FIG. 1, birefringence of compositions having at least 2 wt. % polar additive is readily visible, which indicates that these compositions include liquid crystals. In the bottom images of FIG. 1, the compositions having at least 2 wt. % polar additive are homogenous, while the compositions having less than 2 wt. % polar additive are phase separated.

### Example 2. Silicone Emulsions With 5 wt. % Surfactant and Polar Additive, With Varying Weight Fractions

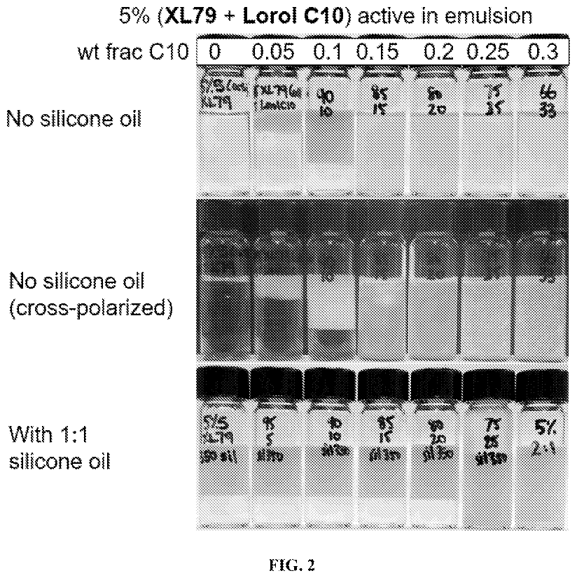

Silicone emulsions were formed with water, silicone oil, and a constant 5 wt. % active surfactant (Lutensol® XL79) and polar additive (Lorol® C10). The emulsions were formed by direct emulsion, followed by vortex-mixing for two minutes. This process was performed twice, with a four-hour time gap between each mixing. The relative weight fraction of polar additive was varied. Related compositions are shown in FIG. 2. In the top images of FIG. 2, compositions including water, surfactant, and polar additive are shown under ordinary light. In the middle images of FIG. 2, compositions including water, surfactant, and polar additive are shown under cross-polarized light. In the bottom images of FIG. 2, compositions including water, surfactant, polar additive, and silicone oil are shown under ordinary light.

As can be seen in the middle images of FIG. 2, birefringence of compositions having at least 0.25 wt. fraction polar additive is readily visible, which indicates that these compositions include liquid crystals. In the bottom images of FIG. 2, the compositions having at least 0.25 wt. fraction polar additive are homogenous, while the compositions having less than 0.25 wt. fraction polar additive are phase separated.

### Example 3. Silicone Emulsions Polar Additive as a Post-Emulsion Additive

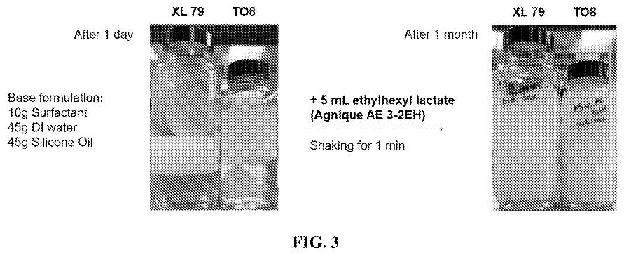

Comparative silicone emulsions were formed by forming a base formulation including 10 g surfactant (Lutensol® XL79 or Lutensol® TO 8), 45 g deionized water, and 45 g silicone oil (350 cSt PDMS). The comparative silicone emulsions are shown in the left image of FIG. 3. As can be seen, the comparative emulsions phase separate after one day.

Inventive silicone emulsions were formed by adding 5 mL of a polar additive (Agnique® AE 3-2EH) to the comparative silicone emulsions and shaking the resulting mixture for about one minute. The inventive silicone emulsions are shown in the right image of FIG. 3. As can be seen, the inventive emulsions remain stable and homogenous after one month.

### Example 4. Catastrophic Inversion of a Silicone Emulsion Containing a 12,500 cSt Silicone Oil

Silicone emulsions were formed with 46.53 wt. % water, 47.19 wt. % silicone oil with a viscosity of 12,500 cSt, 4.38 wt. % active surfactant (Lutensol® XL79) and 1.24 wt. % polar additive (Lorol® C10). A blend was formed by forming a mixture including the surfactant and polar additive. The blend was added to the silicone oil and then the resulting mixture was mixed at 250 rpm. Then water was added at a gradual rate of 1 g/min until catastrophic inversion occurred. After the catastrophic inversion, water was further added at a rate of 2 g/min.

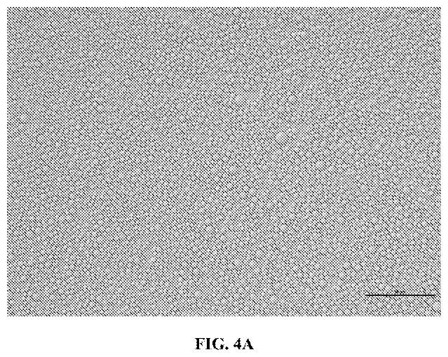

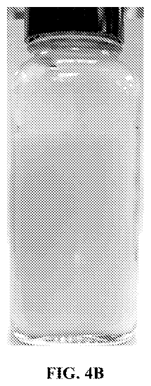

A microscope image of the resulting silicone oil emulsion containing 12,500 cSt silicone oil is shown in FIG. 4A. The silicone oil droplets are relatively small and homogenously dispersed. A photograph of the resulting silicone oil emulsion containing 12,500 cSt silicone oil is shown in FIG. 4B. The emulsion is visibly homogenous.

### Example 5. Catastrophic Inversion of a Silicone Emulsion Containing a 1,000,000 cSt Silicone Oil

Silicone emulsions were formed with 46.53 wt. % water, 47.19 wt. % silicone oil with a viscosity of 1,000,000 cSt, 4.38 wt. % active surfactant (Lutensol® XL79) and 1.24 wt. % polar additive (Lorol® C10). A blend was formed by forming a mixture including the surfactant and polar additive. The blend was added to the silicone oil and then the resulting mixture was mixed at 60 rpm. Then water was added at a gradual rate of 1 g/min until catastrophic inversion occurred. After the catastrophic inversion, the mixture was further mixed at 60-250 rpm. After the mixing, water was further added at a rate of 2 g/min.

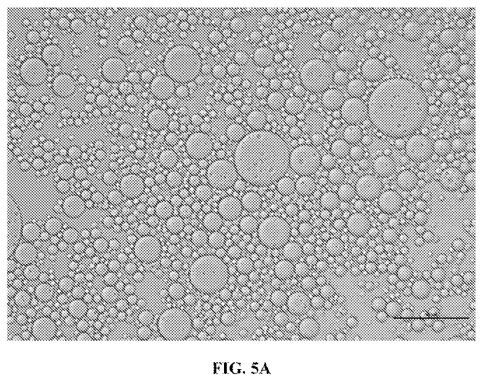

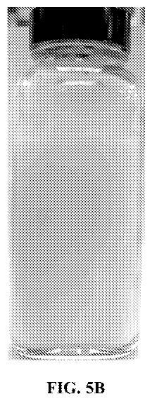

A microscope image of the resulting silicone oil emulsion containing 1,000,000 cSt silicone oil is shown in FIG. 5A. The silicone oil droplets are relatively large and are not homogenously dispersed. A photograph of the resulting silicone oil emulsion containing 1,000,000 cSt silicone oil is shown in FIG. 5B. The emulsion is visibly homogenous.

### Example 6. Silicone Emulsions With 5 wt. % Surfactant and Varying Amounts of Polar Additive

Silicone emulsions were formed with water, silicone oil, 5 wt. % active surfactant (Glucopon® 625UP), and varying amounts of polar additive (Lorol® C10). The emulsions were formed by direct emulsification, followed by vortex-mixing for two minutes. This process was performed twice, with a four-hour time gap between each mixing. Related compositions are shown in FIG. 6. In the top images of FIG. 6, compositions including water, surfactant, and polar additive are shown under ordinary light. In the middle images of FIG. 6, compositions including water, surfactant, and polar additive are shown under cross-polarized light. In the bottom images of FIG. 6, compositions including water, surfactant, polar additive, and silicone oil are shown under ordinary light.

As can be seen in the middle images of FIG. 6, birefringence of the composition having 2 wt. % polar additive is visible, which indicates that this composition includes liquid crystals. In the bottom images of FIG. 6, the composition having 2 wt. % polar additive is homogenous, while the compositions having less than 2 wt. % polar additive are phase separated.

### Example 7. Catastrophic Inversion of a Silicone Emulsion Containing a 1,000,000 cSt Silicone Oil

Silicone emulsions were formed with water, silicone oil with a viscosity of 1,000,000 cSt, 5 wt. % active surfactant (Glucopon® 625UP) and 2 wt. % polar additive (Lorol® C10). A blend was formed by forming a mixture including the surfactant and polar additive. The blend was added to the silicone oil and then the resulting mixture was mixed at 60 rpm. Then water was added at a gradual rate of 1 g/min until catastrophic inversion occurred. After the catastrophic inversion, the mixture was further mixed at 60-250 rpm. After the mixing, water was further added at a rate of 2 g/min.

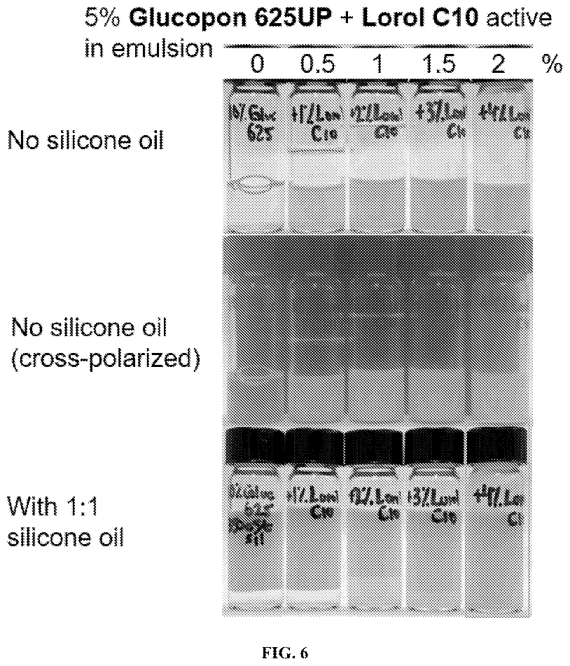

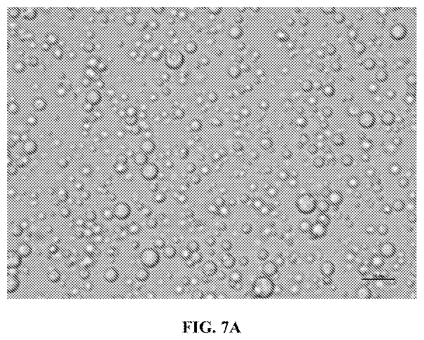

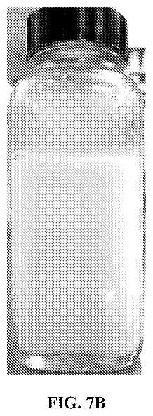

A microscope image of the resulting silicone oil emulsion containing 1,000,000 cSt silicone oil, after dilution by a factor of 10, is shown in FIG. 7A. The silicone oil droplets are a mixture of relatively small and relative large droplets that are homogenously dispersed. A photograph of the resulting silicone oil emulsion containing 1,000,000 cSt silicone oil is shown in FIG. 7B. The emulsion is visibly homogenous.

These examples demonstrate the benefits of using a combination of a surfactant and a polar additive to stabilize waterborne silicone emulsions. Liquid crystals are essential to stabilizing droplets after emulsification. Liquid crystals may be formed from a wide array of surfactants. Silicones having a wide range of viscosity may be emulsified.

### Example 8. Silicone Emulsions With 4 wt. % Surfactant and Varying Amounts of Polar Additive

Silicone emulsions were formed with water, silicone oil, 4 wt. % active surfactant (Lutensol® XL70), and varying amounts of polar additive (NANSA® EVM 70/2E). The emulsions were formed as described above. The amounts of components that resulted in the formation of liquid crystals were 4 wt. % Lutensol® XL 70, 4 wt. % NANSA EVM® 70/2E, and q.s. water. These amounts of components were uncertain before mixing and required experimentation.

Corresponding compositions are shown in FIG. 8. In the top images of FIG. 8, compositions including water, surfactant, and polar additive are shown under ordinary light. In the middle images of FIG. 8, compositions including water, surfactant, and polar additive are shown under cross-polarized light. The middle images of FIG. 8 were taken after two weeks to improve visualization of birefringence. In the bottom images of FIG. 8, compositions including water, surfactant, polar additive, and silicone oil are shown under ordinary light.

The concentration of the polar additive increases from left to right in each image of FIG. 8 as follows: 0 wt. % in the first vial, 2 wt. % in the second vial, 4 wt. % in the third vial, and 6 wt. % in the fourth vial.

As can be seen in the middle images of FIG. 8, birefringence of the composition having 4 wt. % polar additive is visible, which indicates that this composition includes liquid crystals. In the bottom images of FIG. 8, the composition having 4 wt. % polar additive is homogenous, while the compositions having less than 4 wt. % polar additive are phase separated.

One advantage of the use of NANSA® EVM 70/2E, or other polar surfactants, as a polar additive is that the silicone emulsion is temperature-stable.

### Example 9. Silicone Emulsions With 4 wt. % Surfactant, 3 wt. % of a Stabilizer, and Varying Amounts of Polar Additive

Silicone emulsions were formed with water, silicone oil, 4 wt. % active surfactant (Lutensol® XL70), 3 wt. % stabilizer (Pluronic® P105) and varying amounts of polar additive (NANSA® EVM 70/2E). The emulsions were formed as described above. The amounts of components that resulted in the formation of liquid crystals were 4 wt. % Lutensol® XL 70, 8 wt. % NANSA EVM® 70/2E, 3 wt. % Pluronic® P105, and q.s. water. These amounts of components were uncertain before mixing and required experimentation.

Corresponding compositions are shown in FIG. 9. In the top images of FIG. 9, compositions including water, surfactant, stabilizer, and polar additive are shown under ordinary light. In the middle images of FIG. 9, compositions including water, surfactant, stabilizer, and polar additive are shown under cross-polarized light. The middle images of FIG. 9 were taken after two weeks to improve visualization of birefringence. In the bottom images of FIG. 9, compositions including water, surfactant, stabilizer, polar additive, and silicone oil are shown under ordinary light.

The concentration of the polar additive increases from left to right in each image of FIG. 9 as follows: 0 wt. % in the first vial, 2 wt. % in the second vial, 4 wt. % in the third vial, 6 wt. % in the fourth vial, 8 wt. % in the fifth vial, and 10 wt. % in the sixth vial.

As can be seen in the middle images of FIG. 9, birefringence of the composition having 8 wt. % polar additive is visible, which indicates that this composition includes liquid crystals. In the bottom images of FIG. 9, the composition having 8 wt. % polar additive is homogenous, while the compositions having less than 8 wt. % polar additive are phase separated.

One advantage of the use of NANSA® EVM 70/2E, or other polar surfactants, as a polar additive in combination with a stabilizer (e.g., Pluronic® P105) is that the silicone emulsion is temperature-stable.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” means plus or minus 10% of the value.

What is claimed is:

1. An emulsion comprising:
a silicone oil; and
a liquid crystal comprising:
an aqueous solvent;
a polar additive; and
a surfactant;
wherein the surfactant is present in an amount of less than about 20 wt. % of the emulsion.

2. The emulsion of claim 1, wherein the surfactant is selected from the group of ionic surfactants, cationic surfactants, anionic surfactants, amphoteric surfactants, zwitterionic surfactants, nonionic surfactants, alcohol ethoxylates, alcohol alkoxylates, alkyl polyglycosides, alkyl polyglucosides, extended surfactants, surfactants that include intermediate propoxylate groups in between the head group and the tail, and combinations thereof.

3. The emulsion of claim 1, wherein the surfactant is present in an amount of less than about 15 wt. % of the emulsion.

4. The emulsion of claim 1, wherein the surfactant comprises a surfactant that is otherwise not in the form of a liquid crystal when present in an amount of less than about 20 wt. % of the emulsion in the absence of the polar additive.

5. The emulsion of claim 1, wherein the liquid crystal is a lyotropic liquid crystal.

6. The emulsion of claim 1, wherein the polar additive is selected from the group of polar oils, alcohols, alkyl esters, fatty acids, polar aromatics, surfactants, polar surfactants, and combinations thereof.

7. The emulsion of claim 1, wherein the polar additive is present in a wt. fraction relative to the surfactant in a range of from about 0.25 to about 5.0.

8. The emulsion of claim 1, wherein the aqueous solvent comprises water.

9. The emulsion of claim 1, wherein the silicone oil is selected from the group of polydimethylsiloxanes, organo-modified silicones, amino-modified silicones, methyl silicone resins, MQ resins, and combinations thereof.

10. The emulsion of claim 1, wherein the silicone oil has a viscosity in a range of from about 0.65 to about 1,500,000 cSt.

11. The emulsion of claim 1, further comprising a stabilizer selected from the group of surfactants, polymers, solid particles, surface-active proteins, fibers, clays, temperature stabilizers, and combinations thereof.

12. The emulsion of claim 1, wherein the emulsion is an oil-in-water emulsion.

13. A composition comprising the emulsion of claim 1, wherein the composition is selected from the group of sealant compositions, coating compositions, adhesive compositions, elastomer compositions, release agent compositions, texture enhancing compositions, lubricant compositions, defoaming compositions, gloss providing compositions, construction compositions, building material compositions, clay compositions, concrete compositions, concrete compositions for improving water repellency, and personal care compositions.

14. A method of making an emulsion comprising:
a silicone oil; and
a liquid crystal comprising:
an aqueous solvent;
a polar additive; and
a surfactant;
wherein the surfactant is present in an amount of less than about 20 wt. % of the emulsion,
the method comprising:
forming a mixture comprising:
optionally a first amount of the aqueous solvent;
optionally a first amount of the silicone oil;
the polar additive; and
the surfactant, wherein the surfactant is optionally in a form of a liquid crystal;
mixing the mixture;
optionally adding a second amount of the silicone oil; and
optionally adding a second amount of the aqueous solvent.

15. The method of claim 14, wherein the method step of forming a mixture comprises:
forming a first mixture comprising the first amount of the silicone oil and the surfactant; and
adding to the first mixture the polar additive to form a second mixture.

16. The method of claim 14, wherein the method step of forming a mixture comprises:
forming a first mixture comprising the first amount of the aqueous solvent, the polar additive, and the surfactant; and
adding to the first mixture the first amount of the silicone oil to form a second mixture.

17. The method of claim 14, wherein the method step of mixing the mixture comprises mixing the mixture at a rate of less than or equal to about 300 rpm.

18. The method of claim 14, wherein the method step of adding a second amount of the aqueous solvent induces catastrophic inversion of the emulsion.

19. The method of claim 14, wherein the surfactant is not in a form of a liquid crystal during the method step of forming a mixture.

20. A method of using an emulsion comprising:
a silicone oil; and
a liquid crystal comprising:
an aqueous solvent;
a polar additive; and
a surfactant;
wherein the surfactant is present in an amount of less than about 20 wt. % of the emulsion,
the method comprising using the emulsion to form a product selected from the group of sealant compositions, coating compositions, adhesive compositions, elastomer compositions, release agent compositions, texture enhancing compositions, lubricant compositions, defoaming compositions, gloss providing compositions, construction compositions, building material compositions, clay compositions, concrete compositions, concrete compositions for improving water repellency, and personal care compositions.
